(19) United States
(12) Patent Application Publication
(10) Pub. No.: US 2015/0377475 A1
(43) Pub. Date: Dec. 31, 2015

(54) LED Lamp Having Waterproof Structure

(71) Applicant: Wanjiong Lin, Ningbo (CN)

(72) Inventor: Feng Ji, Ningbo (CN)

(73) Assignees: SELF ELECTRONICS CO., LTD., Ningbo (CN); SELF ELECTRONICS USA CORPORATION, Norcross, GA (US)

(21) Appl. No.: 14/586,667

(22) Filed: Dec. 30, 2014

(30) Foreign Application Priority Data
Jun. 25, 2014 (CN) 201410288513.7

(51) Int. Cl. F21V 31/00; F21V 31/04

(52) U.S. Cl. CPC F21V 31/005; F21V 31/04; F21Y 2101/02

(57) ABSTRACT

An LED lamp having waterproof structure includes an elongated shell, a cover coupled onto the elongated shell, two protection plugs respectively inserted into two ends of the elongated shell, two elastic seal bars clamped between the elongated shell and the cover, and two waterproof solid colloids filled among the elongated shell. Since the elastic seal bar has a less length than the elongated shell, and a sealing chamber is formed among the elongated shell, the cover, and the protection plug, spaces for irrigating the liquid glue has been reserved. The liquid glue fills with the sealing chamber, the sealing grooves of the elongated shell, and the gaps among the cover, the protection plug, and the elongated shell and solidifies into and forms the waterproof solid colloid. In result, the LED lamp has a high grade of end waterproof, which is beneficial to expand the usage environment thereof.

### RELATED APPLICATION

This present application claims benefit of the Chinese Application, CN201410288513.7, filed on Jun. 25, 2014.

### BACKGROUND

1. Technical Field

The present application relates to lighting devices, and more particularly to an LED lamp having waterproof structure.

2. Description of the Related Art

Lamps are a very common device in our daily life, such as roadside lamp, factory lighting, and household lighting device. Owing to different locations and purposes, lamps is used in kinds of occasions, such as outdoor illumination and in high humidity environments, especially in a freezer, or a refrigerated cabinet, and so on. Moreover, LED lamp has large luminous flux and can be designed into more ingenuous structure and smaller volume. Therefore, the LED lamp is more adopted to be used in these occasions, such as the freezer, and the refrigerated cabinet which has a limited space to mount the LED lamp. So that, the LED lamp must has higher grade of waterproof.

The traditional LED lamp focuses on side waterproof formed by a shell and a cover coupled onto the shell. And end waterproof has not been placed enough emphasis on the lamp, which restrict usage occasion thereof.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric view of an LED lamp having waterproof structure according to an embodiment.

FIG. 2 is an explosive view of the LED lamp having waterproof structure of FIG. 1.

FIG. 3 is a sectional view of the LED lamp having waterproof structure of FIG. 1 taken along the line A-A.

### DETAILED DESCRIPTION

The present application is illustrated by way of example and not by way of limitation in the figures of the accompanying drawings. It should be noted that references to “an” or “one” embodiment in this application are not necessarily to the same embodiment, and such references mean at least one.

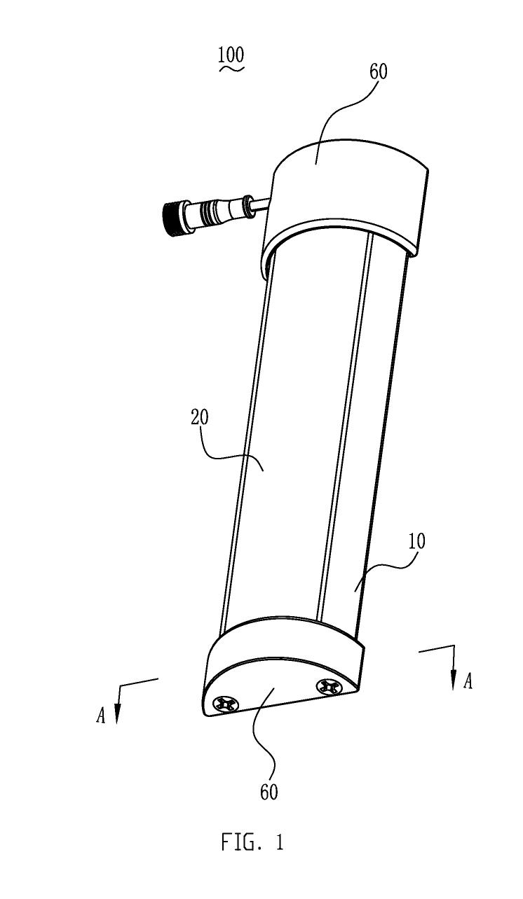

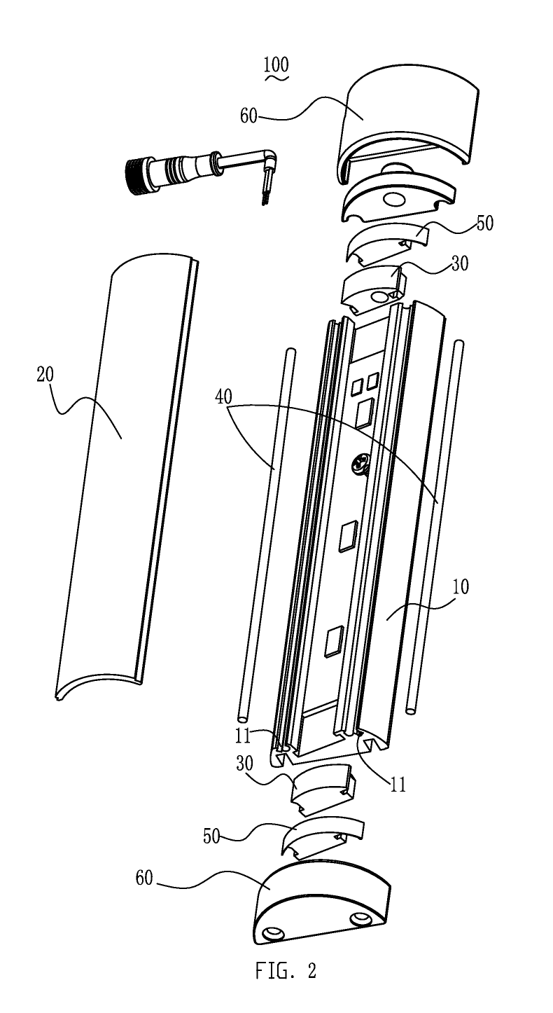

Referring to FIG. 1 and FIG. 2, an LED lamp 100 having waterproof structure according to an embodiment is shown. The LED lamp 100 includes an elongated shell 10, a cover 20 coupled onto the elongated shell 10, two protection plugs 30 respectively inserted into two ends of the elongated shell 10, two elastic seal bars 40 configured for side waterproof, and two waterproof solid colloids 50 configured for end waterproof in cooperation with the elastic seal bar 40 and the protection plug 30. As well known for a person skilled in the art, the LED lamp 100 further includes other components, such as PCB, light sources, and so on.

It need to be explained that the cover 20 is coupled onto the elongated shell 10 and the two protection plugs 30 are respectively clamped between the cover 20 and the elongated shell 10. And, the two protection plugs 30 are far away from the free end of the cover 20 and the elongated shell 10. Therefore, the sealing chamber 60, which is a semi-open cavity, is formed among the elongated shell 10, the cover 20, and the protection plug 30. The sealing chamber 60 has a depth along an axial direction of the elongated shell 10 that is a minimum distance between the protection plug 30 and the free end of the cover 20. The depth of the sealing chamber 60 is set according to the desired thickness of the waterproof solid colloid 50. Repeated testing, the LED lamp 100 has a higher waterproof grade when the depth of the sealing chamber 60 is equal to or greater than 3 mm. Understandably, the other components, such as PCB, light sources, and so on, are received into between the two protection plugs 30.

As shown in FIG. 1 and FIG. 2, the elongated shell 10 is used for mounting all of components, such as the cover 20, PCB, the elastic seal bar 40, and so on. The elongated shell 10 may be made of various materials, such as plastic, metal, etc. In the present embodiment, the elongated shell 10 is formed by extruding aluminum allow and has U-styled slot for mounting the PCB. The elongated shell 10 includes two sealing grooves 11 which are opened in the two sides of U-styled slot along the axial direction thereof respectively. The two sealing grooves 11 are used to arrange the two elastic seal bar 40 respectively. The sealing groove 11 has a cross section area less than that of the elastic seal bar 40 so that the elastic seal bar 40 can tightly couple with the sealing groove 11 so as to realize side waterproof of the LED lamp 100.

The cover 20 may be made of various transparent materials or translucent materials and have various shape. In the present embodiment, the cover 20 has an arched shape and the two sides of the cover 20 are mounted onto the elongated shell 10. The cover 20 is coupled onto the elongated shell 10 via various methods. In the present embodiment, the elongated shell 10 has two slots (not labeled) respectively opened on the two side walls so as to mount the cover 20 inserted therein. When the cover 20 is mounted onto the elongated shell 10, the two elastic seal bar 40 tightly press against the inner wall of the cover 20 so as to realize the side waterproof of the LED lamp 100.

The protection plug 30 may be made of various materials, such as plastic, rubber, wood, and so on. The two protection plugs 30 are respectively clamped between the cover 20 and the elongated shell 10 so as to prevent the liquid glue of the waterproof solid colloid 50 from flowing into the space therebetween and make the liquid glue solid into the waterproof solid colloid 50 which has a special shape. In the present embodiment, for preventing the liquid glue from flowing into the space, the cross section of the protection plug 30 has an arc shape which matches with the inner wall of the cover 20 and a U shape which matches with that of the inner wall of the elongated shell 10. It is optimized that the side wall of the protection plug 30 has some slots or some bars for matching with the inner wall of the elongated shell 10.

The two elastic seal bars 40 are respectively received into the sealing grooves 11 of the elongated shell 10. The elastic seal bar 40 may has a cross section which has various shape, such as rectangle, triangle, circular, irregular polygon, and so on. In the present embodiment, the elastic seal bar 40 is a circle-shaped bar so as to improve the fit of the elastic seal bar 40 and the sealing groove 11 for increasing waterproof grade. The elastic seal bar 40 has a less axial length than the sealing groove 11 or the elongated shell 10 and has a larger axial length than the minimum distance between the two protection plugs 30. Therefore, the elastic seal bar 40 has an end surface which is flushed with at least one cross section of the protection plug 30 along the axial direction of the elongated shell 10. That is to say, the end surface of the elastic seal bar 40 may be flushed with a cross section of the protection plug 30 which far away from the sealing chamber 60 or be flushed with a cross section of the protection plug 30 which is adjacent to the sealing chamber 60. In the present embodiment, the end surface of the elastic seal bar 40 is flushed with the cross section of the protection plug 30 which is adjacent to the sealing chamber 60. For make the two end of the LED lamp 100 have same waterproof grade, the distances from the two end surfaces of the elastic seal bar 40 to that of the sealing groove 11 are identical. As the elastic seal bar 40 has a less axial length than the sealing groove 11, the under-mentioned liquid glue can fill with the rest of the sealing groove 11 and permeate into the narrow gap between the sealing groove 11 and the elastic seal bar 40.

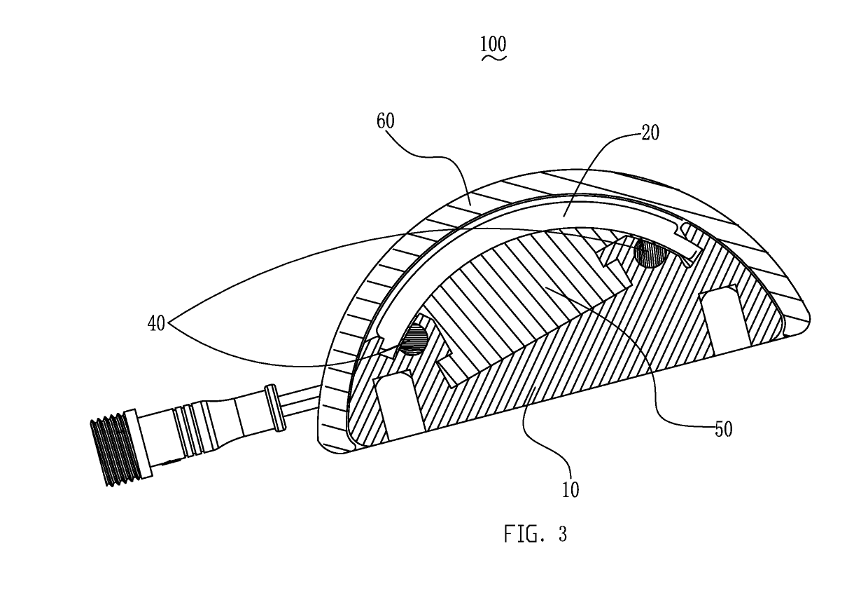

As shown in FIG. 2 and FIG. 3, the waterproof solid colloid 50 is solidified from the liquid glue which fills with the sealing chamber 60 and the gaps among the elastic seal bar 40, the protection plug 30, the cover 20, and the elongated shell 10. The waterproof solid colloid 50 has a thickness along the axial direction of the elongated shell 10 which is set with the requirements of waterproof grade. In order to improve the beauty and increase waterproof grade, the liquid glue fills with the sealing chamber 60 and the sealing groove 11 so that the waterproof solid colloid 50 is aligned with the end surface of the elongated shell 10. The waterproof solid colloid 50 may be made of glass cement, neutral silicon rubber, and so on. After waterproof testing, the waterproof grade of the LED lamp having the waterproof solid colloid 50 can reach IP65 (IP: International Protection).

As shown in FIG. 1, the LED lamp 100 further includes two end caps 70. The two end caps 70 are respectively coupled onto the two ends of the elongated shell 10. The end cap 70 may be made of plastic so as to avoid the waterproof solid colloid 50 from wearing and improve the whole beauty of the LED lamp 100.

The LED lamp 100 further includes a PCB mounted on the elongated shell 10, at least one LED chip connected to the PCB, and power and wires electrically connected to the LED chip.

In use, since the elastic seal bar 40 has a less length than the elongated shell 10, and a sealing chamber 60 is formed among the elongated shell 10, the cover 20, and the protection plug 30, spaces for irrigating the liquid glue are reserved. The liquid glue fills with the sealing chamber 60, the sealing grooves 11 of the elongated shell 10, and the gaps among the cover 20, the protection plug 30, and the elongated shell 10 and solidifies into and forms the waterproof solid colloid 50. In result, the LED lamp 100 has a high grade of end waterproof, which is beneficial to expand the usage environment thereof.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An LED lamp having waterproof structure comprising an elongated shell, a cover coupled onto the elongated shell, two protection plugs respectively inserted into two ends of the elongated shell, two elastic seal bars clamped between the elongated shell and the cover, and two waterproof solid colloids filled among the elongated shell, the cover and the protection plug, the elongated shell comprising two sealing grooves opened thereon along the axial direction thereof and configured for receiving the elastic seal bar respectively, the elastic seal bar has a length less than that of the sealing groove and has an end surface which is flushed with at least one cross section surface of the protection plug along the axial direction of the elongated shell so as to form a sealing chamber among the elongated shell, the cover and the protection plug, the waterproof solid colloids are solidified from liquid glue which fill with the sealing chamber, the sealing groove, and the gaps between the elongated shell, the cover and the protection plug.

2. The LED lamp having waterproof structure of claim 1, wherein the sealing groove has a less cross section area than that of the elastic seal bar so as that the elastic seal bar fills with the space between the sealing groove and the cover.

3. The LED lamp having waterproof structure of claim 1, wherein the sealing chamber has a depth of larger than or equal to 3 mm along the axial direction of the elongated shell.

4. The LED lamp having waterproof structure of claim 1, wherein the waterproof solid colloids are aligned with the end surface of the elongated shell.

5. The LED lamp having waterproof structure of claim 1, wherein the distances from the two end surface of the elastic seal bar to that of the sealing groove is identical.

6. The LED lamp having waterproof structure of claim 1, wherein the end surface of the elastic seal bar is flushed with a cross section surface of the protection plug which far away from the sealing chamber.

7. The LED lamp having waterproof structure of claim 1, wherein the end surface of the elastic seal bar is flushed with a cross section surface of the protection plug which is adjacent to the sealing chamber.

8. The LED lamp having waterproof structure of claim 1, wherein the end surface of the cover is flushed with that of the elongated shell.

9. The LED lamp having waterproof structure of claim 1, wherein the LED lamp further comprises two end caps which respectively couple onto the two ends of the elongated shell.
